(19) United States
(12) Patent Application Publication
(10) Pub. No.: US 2025/0003024 A1
(43) Pub. Date: Jan. 2, 2025

(54) EXTRACTION COLUMN FOR METAL SEPARATION IN ACID LEACHING SOLUTION OF LATERITE NICKEL ORE AND EXTRACTION PROCESS THEREOF

(71) Applicant: Institute of Process Engineering Chinese Academy of Sciences, Beijing (CN)

(72) Inventors: Huiquan LI, Beijing (CN); Chenye WANG, Beijing (CN); Chi WANG, Beijing (CN); Yong WANG, Beijing (CN); Peng XING, Beijing (CN)

(73) Assignee: Institute of Process Engineering Chinese Academy of Sciences, Beijing (CN)

(21) Appl. No.: 18/882,380

(22) Filed: Sep. 11, 2024

Related U.S. Application Data
(63) Continuation of application No. PCT/CN2024/078134, filed on Feb. 22, 2024.

(30) Foreign Application Priority Data
Jan. 9, 2023 (CN) 202310025320.1

(51) Int. Cl. C22B 3/02; C22B 3/06; C22B 3/34; C22B 23/00

(52) U.S. Cl. CPC C22B 3/02; C22B 3/06; C22B 3/34; C22B 23/00

(57) ABSTRACT

This disclosure discloses an extraction column for metal separation in an acid leaching solution of laterite nickel ore, and an extraction process thereof. The extraction column includes an extraction column tube body and a gas distribution device; an interior of the extraction column tube body is provided with an accommodating cavity for containing a continuous phase and a dispersed phase, the continuous phase and the dispersed phase are in countercurrent contact in the accommodating cavity; and the extraction column tube body is connected with the gas distribution device to make the gas distribution device pass gas into the accommodating cavity. The gas distribution device is used to control a pipe diameter of a gas outlet of the gas distribution device in a suitable range. Using turbulent effect of bubbles floating in a liquid phase, collisions and shears of the dispersed phase form dispersed phase droplets with suitable sizes.

### CROSS-REFERENCE TO RELATED APPLICATION

The present application is a bypass continuation application filed under 35 U.S.C. 111 (a) of International Application No. PCT/CN2024/078134 filed on Feb. 22, 2024, which claims priority to Chinese application No. 202310025320.1 filed on Jan. 9, 2023, and entitled “Extraction Tower and Extraction Process for Metal Separation in Lateritic Nickel Ore Acid Leaching Solution”, each of which is hereby incorporated by reference in its entirety.

### FIELD

This disclosure is related to the field of extraction devices and processes, especially to an extraction column for metal separation in an acid leaching solution of laterite nickel ore, and an extraction process thereof.

### BACKGROUND

The acid leaching method is currently a relatively mature process for the hydrometallurgical application of laterite nickel ore. However, during the leaching of valuable metals such as nickel and cobalt, impurity metal ions including manganese, copper, zinc, calcium, iron, and aluminum also dissolve into the leaching solution simultaneously. The traditional step-by-step precipitation process is difficult to achieve the purpose of accurate separation of nickel, cobalt and other impurity ions. Extraction is the most common method for separating similar metals. In order to raise the mass transfer process in extraction columns, external energy fields can be introduced into the extraction column.

In related technology, stirring is a commonly used ways to introduce energy into the extraction column, remarkably improving the mass transfer performance of the liquid-liquid phase. However, uneven stirring can lead to flooding in the extraction column. In another related technology, a pulsation device is set in the extraction column. To obtain more extraction stages, the height of the extraction column is typically around 10 m to 20 m. The pulse device, usually arranged at the bottom of the extraction column, endures substantial physical pressure, frequently resulting in leakage or damage of the pulse device, which leads to a entire production line parking maintenance.

### SUMMARY

This disclosure provides an extraction column for metal separation in an acid leaching solution of laterite nickel ore and an extraction process thereof.

In the first aspect, this disclosure provides extraction column for metal separation in an acid leaching solution of laterite nickel ore, comprising: an extraction column tube body and a gas distribution device. An interior of the extraction column tube body is provided with an accommodating cavity for containing a continuous phase and a dispersed phase, making the continuous phase and the dispersed phase in countercurrent contact in the accommodating cavity. The extraction column tube body is connected with the gas distribution device to make the gas distribution device pass gas into the accommodating cavity.

In some embodiments, the gas distribution device comprises a gas distribution pipeline network. The gas distribution pipeline network is formed by a plurality of splicing gas distribution pipelines, and an end of each the gas distribution pipeline is provided with a gas outlet component. The gas distribution pipeline network is provided with an gas inlet pipeline, making a gas flow from the gas inlet pipeline into the gas distribution pipeline of the gas distribution pipeline network and flow out to the accommodating cavity through the gas outlet component.

In some embodiments, a cross section of the gas distribution pipeline network is a central symmetric figure. An outer contour of the central symmetric figure extends to an inner wall of the extraction column tube body, and the central symmetric figure comprises at least one of a square, a regular hexagon, or other regular polygon.

In some embodiments, the gas inlet pipeline is arranged at a center position of a side of the gas distribution pipeline network facing a bottom of the extraction column tube body. A pipe diameter of the gas inlet pipeline is larger than a pipe diameter of the gas distribution pipeline. The gas inlet pipeline is set at a geometric center of the gas distribution pipeline network.

In some embodiments, the gas outlet component comprises a connecting pipe and a gas outlet. One end of the connecting pipe is connected with the gas distribution pipeline, and the other end of the connecting pipe bends towards the bottom of the extraction column tube body and is connected with an inlet end of the gas outlet

In some embodiments, the bending angle of the connecting pipe is between 45° and 90°, which means one end of the connecting pipe is connected to the gas distribution pipeline, and the other end of the connecting pipe is bent 45° to 90° towards the bottom of the extraction column tube body.

In some embodiments, a cross-sectional area of the inlet end of the gas outlet is larger than a cross-sectional area of an outlet end of the gas outlet.

In some embodiments, the bottom of the accommodating cavity is provided with the gas distribution device.

In some embodiments, an inner wall of the accommodating cavity is provided with spaced baffles, and the baffles comprises a annular baffle and a plate baffle.

In some embodiments, the annular baffle and the plate baffle are cross-set in turn.

In some embodiments, a ring inner diameter of the annular baffle is 40% to 70% of an inner diameter of the extraction column tube body.

In some embodiments, a ratio of a projected area of the plate baffle to the annular baffle along a height direction of the extraction column tube body is 0.3 to 0.55.

In some embodiments, the gas distribution device is connected with a gas inlet peristaltic pump on a side of the extraction column tube body.

In some embodiments, a check valve is provided between the gas distribution device and the gas inlet peristaltic pump, and the check valve is a one-way valve, and the check valve is used for gas intake from an outside of the extraction column to an inside of the extraction column.

In some embodiments, the gas outlet is a conical joint.

In the second aspect, this disclosure provides an extraction process using the described extraction column, including the following steps:
(1) injecting the continuous phase into the accommodating cavity of the extraction column through a top of the extraction column, and injecting the dispersed phase into the accommodating cavity of the extraction column through a bottom of the extraction column to make the continuous phase and the dispersed phase be in countercurrent contact in the accommodating cavity;
(2) activating a gas inlet peristaltic pump on a side of the extraction column to make the gas flow into the gas distribution pipeline of the gas distribution pipeline network through the gas inlet pipeline and flow out to the accommodating cavity through an outlet end of the gas outlet;
   Wherein, the extraction column comprises an extraction column tube body and a gas distribution device;
   an interior of the extraction column tube body is provided with an accommodating cavity for containing a continuous phase and a dispersed phase, making the continuous phase and the dispersed phase in countercurrent contact in the accommodating cavity; and
   the extraction column tube body is connected with the gas distribution device to make the gas distribution device pass gas into the accommodating cavity; and
   the gas distribution device comprises a gas distribution pipeline network; and
   the gas distribution device is connected with a gas inlet peristaltic pump on the side of the extraction column tube body; and
   the gas distribution pipeline network is formed by a plurality of splicing gas distribution pipelines; and
   an end of each the gas distribution pipeline is provided with a gas outlet component; and
   the gas distribution pipeline network is provided with an gas inlet pipeline, making gas flow from the gas inlet pipeline into the gas distribution pipeline of the gas distribution pipeline network and flow out to the accommodating cavity through the gas outlet component; and the gas outlet component comprises a connecting pipe and a gas outlet.

In some embodiments, the continuous phase is a mixed solution of extractant P₂O₄ and sulfonated kerosene. The dispersed phase is a sulfate solution comprising Ni²⁺, Co²⁺, Mn²⁺, Mg²⁺, Cu²⁺, and Zn²⁺; and the gas is selected from at least one of air, nitrogen, and carbon dioxide.

In some embodiments, an injection flow rate of the continuous phase is recorded as D1 L/h, an injection flow rate of the dispersed phase is recorded as D2 L/h, and an injection flow rate of the gas is recorded as D3 L/h, satisfying: 1≤D3/(D1+D2)≤2.5, and a diameters of the gas outlet ranging from 2 mm to 4 mm. Specifically, the diameter of the outlet end of the gas outlet is 2 mm to 4 mm. In some embodiments, the diameter of the gas outlet is 3 mm to 4 mm. Further, in some embodiments, a diameter of the gas outlet is 3 mm. Further, to meet the requirement of 1.75≤D3/(D1+D2)≤2.3, with an outlet diameter of 3 mm to 4 mm, the average diameter of the dispersed phase droplets formed may be controlled within the range of 1.35 mm to 1.4 mm.

In some embodiments, a ratio D3/(D1+D2) of an injection flow rate of the gas to a sum of the liquid-liquid two-phase flow rate (i.e. the sum of the injection flow rates of the continuous phase and the dispersed phase) is 1, 1.2, 1.4, 1.5, 1.6, 1.8, 2, 2.2, 2.3, 2.5, or a range of any two of the above two values.

In some embodiments, a diameter of the outlet end of the gas outlet is 2 mm, 2.2 mm, 2.4 mm, 2.5 mm, 2.6 mm, 2.8 mm, 3 mm, 3.2 mm, 3.4 mm, 3.5 mm, 3.6 mm, 3.8 mm, 4 mm or a range of any two of the above two values.

In some embodiments, an injection flow rate of the gas is between 22 L/h and 45.5 L/h, and a sum of the injection flow rates of the continuous and dispersed phases is between 19.5 L/h and 21 L/h. Preferably, an injection flow rate of the gas is between 34 L/h and 45.5 L/h.

In some embodiments, an injection flow rate of the gas is 22 L/h, 24 L/h, 26 L/h, 28 L/h, 30 L/h, 32 L/h, 34 L/h, 36 L/h, 38 L/h, 40 L/h, 42 L/h, 44 L/h, 45 L/h, 45.3 L/h, 45.5 L/h, or a range of any two of the above two values.

In some embodiments, a sum of injection flow rate for the continuous phase and dispersed phase is 19.5 L/h, 19.8 L/h, 20 L/h, 20.2 L/h, 20.4 L/h, 20.6 L/h, 20.8 L/h, 21 L/h, or a range of any two of the above two values.

In some embodiments, the diameter of the gas outlet indicates an inner diameter of an end of the gas outlet.

In some embodiments, the dispersed phase droplets refer to a sulfate leaching solution containing Ni2+, Co2+, Mn2+, Mg2+, Cu2+, and Zn2+. Under the collisions and shears of bubbles, it will form a droplet shape in the continuous phase, which is a dispersed phase droplet. An average droplet diameter of the dispersed phase droplets is measured by the image method. After the extraction column runs stably under fixed operating conditions for 20 minutes, a set of well dispersed droplet group photos are taken with the help of a high-speed camera, and the photos are imported into a self-designed d32measure software. A 2 mm thick tray is used as a reference material (scale), and diameters of 300-500 droplets are calculated. The calculation formula is:

$${d}_{32} = \frac{{\sum }_{i = l}^{n} {d}_{i}^{3}}{{\sum }_{i = l}^{n} {d}_{i}^{2}} .$$

In some embodiments, an effect height of the extraction column ranging from 1.8 m to 2.2 m, an inner diameter of the extraction column ranging from 28 mm to 32 mm, and the accommodating cavity of the extraction column is provided with baffles, the spacing of the baffles ranging from 1 cm to 1.5 cm.

### DESCRIPTION OF DRAWINGS

In order to more clearly explain implementation embodiments of this disclosure or solutions in descriptions of the prior art. The following will be a brief introduction to the drawings that need to be used in implementation embodiments of this disclosure or descriptions of the prior art. It is obvious that drawings described below are only some embodiments of the present disclosure. For those skilled in the art, other drawings may be obtained based on these drawings without creative labor.

FIG. 1 is a structural diagram of the extraction column in a embodiment of the present disclosure.

FIG. 2 is a structural diagram of first perspective of a gas inlet device in a embodiment of the present disclosure.

FIG. 3 is a structural diagram of second perspective of a gas inlet device in a embodiment of the present disclosure.

The drawings include: 1. Extraction column; 11. Extraction column tube body; 12. Upper clarifying tank; 121. Exhaust valve; 13. Lower clarifying tank; 131. Drain valve; 111. Accommodating cavity; 112. Heavy phase feed distributor; 113. Baffle; 2. First heavy phase storage tank; 21. Heavy phase feed pump; 3. Second heavy phase storage tank; 31. Heavy phase discharge pump; 4. First light phase storage tank; 41. Light phase feed pump; 5. Second light phase storage tank; 6. Gas distribution device; 61. Gas distribution pipeline; 62. Gas outlet component; 621. Connecting pipe; 622. Gas outlet; 63. Gas inlet pipeline; 7. Gas inlet peristaltic pump; 71. Check valve.

### DETAILED DESCRIPTION OF EMBODIMENTS

To further clarify the objectives, technical solutions, and advantages of this disclosure, detailed descriptions are provided with accompanying drawings and embodiments. It should be understood that these specific embodiments are merely illustrative and not limiting to this disclosure.

Extraction column is an essential separation equipment in the field of extraction. It has advantages of strong continuity, high safety, and low investment. The basic principle is that a dispersed phase is in the form of small droplets, relying on a density difference with a continuous phase, and countercurrent contact in the extraction column to achieve a purpose of mass transfer. However, if only relying on the density difference, the operating capacity of the extraction column is small and it is easy to cause flooding. Currently, an enhancement of mass transfer in the extraction column mainly relies on optimizing internal components of the extraction column and introducing external field energy. Pulse and stirring are the most commonly used methods to introduce energy into the extraction column, remarkably improving liquid-liquid mass transfer performance. However, uneven stirring may easily lead to flooding in the extraction column. When the extraction column is flooded, the extraction column will stop running and extend a cycle of an extraction process, which is not conducive to follow-up work. A pulse device is usually installed at the extraction column. The higher the height of the extraction column is, the greater the physical pressure the pulse device will bear. In order to achieve a higher extraction stage, a column height of the extraction column is usually set at about 10 m to 20 m. At this time, the physical pressure of the pulse device is too large, resulting in leakage of the pulse device or even damage of the pulse device, which ultimately leads to a stop of an entire production line. In order to solve the above technical problems, this disclosure improves the external field energy of the extraction column into a mild gas-driven dispersion method on the basis of a baffle extraction column, and provides an extraction column, which is especially suitable for separation of similar metals in an acid leaching solution of laterite nickel ore.

### An Extraction Column for Metal Separation in an Acid Leaching Solution of Laterite Nickel Ore

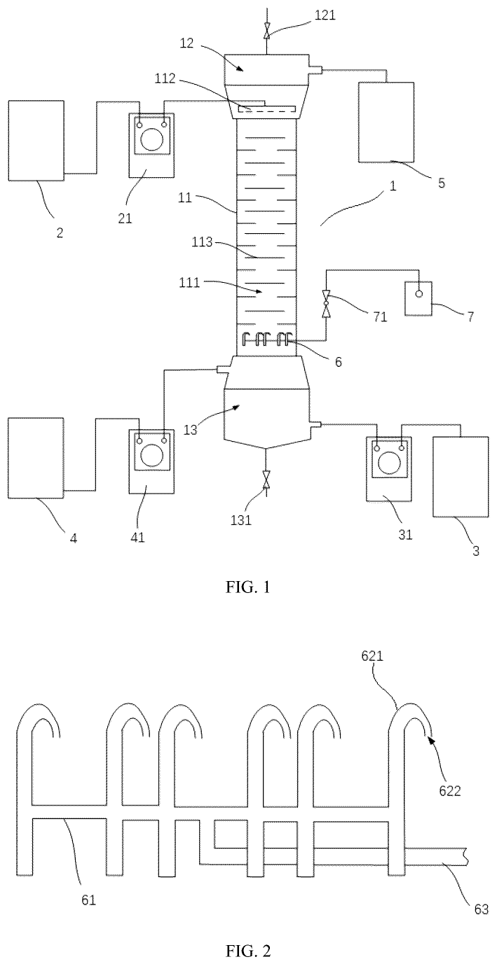

Refer to FIG. 1. The extraction column 1 includes an extraction column tube body 11. A top of the extraction column tube body 11 is provided with an upper clarifying tank 12, a top of the upper clarifying tank 12 is provided with an exhaust valve 121, and a top side of the upper clarifying tank 12 is connected with a second light phase storage tank 5. A bottom of the extraction column tube body 11 is provided with a lower clarifying tank 13, a bottom of the lower clarifying tank 13 is provided with a drain valve 131, a bottom side of the lower clarifying tank 13 is connected to a second heavy phase storage tank 3, and a heavy phase discharge pump 31 is arranged between the lower clarifying tank 13 and the second heavy phase storage tank 3. An interior of the extraction column tube body 11 is provided with an accommodating cavity 111 for a continuous phase and a dispersed phase. A heavy phase feed distributor 112 is arranged at the top of the accommodating cavity 111. The heavy phase feed distributor 112 is connected with a first heavy phase storage tank 2 arranged on a top side of the extraction column tube body 11. A heavy phase feed pump 21 is arranged between the first heavy phase storage tank 2 and the heavy phase feed distributor 112. The first heavy phase storage tank 2 is used to store the continuous phase. During operation, the continuous phase flows out from the first heavy phase storage tank 2, flows into the heavy phase feed distributor 112 through the the heavy phase feed pump 21, flows into the accommodating cavity 111 after being distributed by the heavy phase feed distributor 112, and then flows out through the lower clarifying tank 13 and the heavy phase discharge pump 31 to the second heavy phase storage tank 3 in turn. A bottom of the accommodating cavity 111 is connected with the first light phase storage tank 4, and a light phase feed pump 41 is also arranged between the first light phase storage tank 4 and the extraction column tube body 11. The first light phase storage tank 4 is used to store the dispersed phase. When working, the dispersed phase flows out from the first light phase storage tank 4, flows into the accommodating cavity 111 through the light phase feed pump 41, and then flows out through the upper clarifying tank 12 to the second light phase storage tank 5.

In addition, an inner wall of the accommodating cavity 111 is also provided with spaced baffles 113. The baffles 113 including annular and plate baffles. The annular baffle and the plate baffle are cross-set in turn. A gas distribution device 6 is located at a bottom of the accommodating cavity 111. At this time, a transmission path of bubbles is longer, which is conducive to better improving a state of dispersed phase and better mass transfer effect. The gas distribution device 6 is connected with a gas inlet peristaltic pump 7 on a side of the extraction column tube body 11. There is also a check valve 71 between the gas distribution device 6 and the gas inlet peristaltic pump 7. The check valve 71 is a one-way valve, and the check valve 71 is used for gas intake from an outside of the extraction column 1 to an inside of the extraction column 1. When working, the gas inlet peristaltic pump 7 is opened, and the gas flows into the gas distribution device 6 through the gas inlet peristaltic pump 7 and the check valve 71, and flows out from the gas distribution device 6 into the accommodating cavity 111. Further, a ring inner diameter of the annular baffle is 40% to 70% of an inner diameter of the extraction column tube body 11, and a ratio of a projected area of the plate baffle to the annular baffle along a height direction of the extraction column tube body 11 is 0.3 to 0.55. In this disclosure, the gas distribution device 6 is arranged inside the extraction column 1. The gas distribution device 6 is used to inject gas into the accommodating cavity 111 of the extraction column 1. Through the turbulent action of bubble floating, the dispersed phase may be collided and sheared, so that the dispersed phase may be dispersed in the continuous phase in a good state, which is beneficial to improve a dispersion behavior of the dispersed phase and is not easy to occur flooding. It is beneficial to strengthen the mixing process of the liquid-liquid system, and then strengthen the extraction mass transfer process, and the effect of the mass transfer is good.

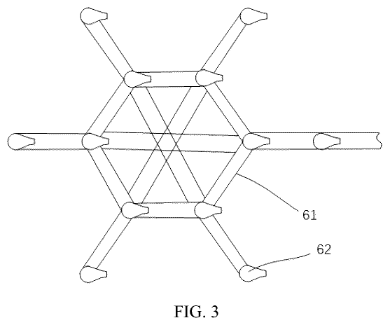

Refer to FIG. 2 and FIG. 3. The gas distribution device 6 is a gas distribution pipeline network, The gas distribution pipeline network is formed by many splicing gas distribution pipelines 61. An end of each the gas distribution pipeline 61 is provided with a gas outlet component 62. and the gas distribution pipeline network is provided with an gas inlet pipeline 63, and a gas flows from the gas inlet pipeline 63 into the gas distribution pipeline 61 of the gas distribution pipeline network and flows out to the accommodating cavity 111 through the gas outlet component 62. Splicing the gas distribution pipelines 61 into a pipeline network and installing the gas outlet component 62 at the end of the pipeline are easier to fulfil in terms of process compared with a pipe network with a gas outlet component set up by punching after integral forming.

According to FIG. 3, a cross section of the gas distribution pipeline network is a central symmetric figure. It is beneficial to an uniform distribution of the gas in the gas distribution pipeline 61. An outer contour of the central symmetric figure extends to an inner wall of the extraction column tube body 11, which may increase a contact range between the dispersed phase and the gas, and improve the mass transfer effect. The central symmetric figure comprises at least one of a square, a regular hexagon, or other regular polygon. At this point, a centrally symmetrical gas distribution pipeline network structure makes gas distribution more uniform, facilitating full contact between bubbles and dispersed phases, and achieving better mass transfer efficiency. In this disclosure, the gas distribution pipeline network is formed by splicing heads and tails of multiple gas distribution pipelines 61, and the gas outlet component 62 is set at a splicing position of the gas distribution pipeline network (the splicing position of the gas distribution pipeline network is an end of the gas distribution pipeline 61). At the same time, a shape of the gas distribution pipeline network is controlled to be a centrosymmetric regular polygon. Especially a regular hexagon shown in Figure. 3 of this disclosure. At this time, a distribution of the gas outlet component 62 is wider and more uniform, which is conducive to the contact between the gas and the dispersed phase, thereby improving the mass transfer effect. At the same time, a splicing process of the regular hexagon is easier to implement than a shape of other polygon with more edges. The gas inlet pipeline 63 is arranged at a center position of a side of the gas distribution pipeline network facing a bottom of the extraction column tube body 11, which is beneficial to realize uniform transmission of the gas in the gas distribution pipe network. At the same time, a pipe diameter of the gas inlet pipeline 63 is controlled to be larger than that of the gas distribution pipeline 61. At this time, it is beneficial for the gas inlet pipeline 63 to lift the gas distribution pipe network and realize the self-support of the gas distribution pipe network. The gas inlet pipeline 63 is set at a geometric center of the gas distribution pipeline network, which is beneficial to gas transmission in the gas distribution pipeline 62 and makes the gas transmission more uniform. At the same time, the pipe diameter of the gas inlet pipeline 63 is controlled to be larger than the pipe diameter of the gas distribution pipeline 62, which is beneficial to realize the self-support of the gas distribution pipeline network, that is, no other structural parts are needed for auxiliary fixation during installation.

According to FIG. 2, the gas outlet component 62 comprises a connecting pipe 621 and a gas outlet 622. One end of the connecting pipe 621 is connected with the gas distribution pipeline 61, and the other end of the connecting pipe 621 bends towards the bottom of the extraction column tube body 11 and is connected with an inlet end of the gas outlet 622. By bending one end of the connecting pipe 621 to the gas outlet 622 towards the bottom of the extraction column tube body 11, the primary impurities generated by reaction, hydrolysis or entering the extraction column 1 may be effectively prevented from depositing at an outlet end of the gas outlet 622, so as to avoid a blockage of the gas outlet 622, which is conducive to achieving good self-cleaning ability. Moreover, a cross-sectional area of the inlet end of the gas outlet 622 is larger than a cross-sectional area of an outlet end of the gas outlet 622. It facilitates controlling suitable bubble size and making shearing dispersed phase to form suitable dispersed phase droplets, improving mass transfer efficiency. For example, the gas outlet 622 described in this disclosure is a conical joint. At this time, a small diameter of the gas outlet 622 is beneficial to strengthen flow intensity of outflow air and increase the mass transfer driving force. The bending angle of the connecting pipe 621 is between 45° and 90°, which means one end of the connecting pipe 621 is connected to the gas distribution pipeline 61, and the other end of the connecting pipe 621 is bent 45° to 90° towards the bottom of the extraction column tube body 11. At this time, it can effectively prevent blockages of the outlet caused by deposition of primary impurities during reaction, hydrolysis, or entering the column, and has good self-cleaning ability.

An extraction process of the extraction column for metal separation in an acid leaching solution of laterite nickel ore, comprising following steps:

(1) Injecting the continuous phase into the accommodating cavity of the extraction column through a top of the extraction column, and injecting the dispersed phase into the accommodating cavity of the extraction column through a bottom of the extraction column to make the continuous phase and the dispersed phase be in countercurrent contact in the accommodating cavity;

Specifically, the continuous phase flows out from the first heavy phase storage tank 2, flows into the heavy phase feed distributor 112 through the heavy phase feed pump 21, and flows into the accommodating cavity 111 after being distributed by the heavy phase feed distributor 112. The dispersed phase flows out from the first light phase storage tank 4, and flows into the accommodating cavity 111 through the light phase feed pump 41, so that the continuous phase and the dispersed phase are in countercurrent contact in the accommodating cavity 111. After that, the continuous phase flows through the lower clarifying tank 13 and the heavy phase discharge pump 31 in turn to the second phase storage tank 3, and the dispersed phase flows through the upper clarifying tank 12 to the second light phase storage tank 5;

(2) Activating a gas inlet peristaltic pump on a side of the extraction column to make the gas flow into the gas distribution pipeline of the gas distribution pipeline network through the gas inlet pipeline and flow out to the accommodating cavity through an outlet end of the gas outlet;

Specifically, turn on the gas inlet peristaltic pump 7 on one side of the extraction column 1, so that the gas sequentially passes through the gas inlet peristaltic pump 7 and check valve 71, and flows into the gas distribution pipeline 61 in the gas distribution pipeline network through the gas inlet pipeline 63. Then, the gas flows out from the gas outlet 622 of the gas distribution pipeline 61 into the accommodating cavity 111. The gas is converted into bubbles in a liquid phase, and turbulent effects are generated during the bubble ascent process, colliding and shearing the dispersed phase, strengthening the mixing process of a liquid-liquid system (a system including continuous and dispersed phases), allowing the dispersed phase to disperse in a good state (mainly reflected in the appropriate size of dispersed phase droplets) in the continuous phase, thereby improving mass transfer. Remaining gas will be discharged from the exhaust valve 121, and waste will be discharged from the drain valve 131.

In the following, the extraction column 1 in this disclosure will be described in detail with implementation embodiments of specific parameters.

### Extraction Column and Extraction System

The effective height of the extraction column is 2 m, and an inner diameter of the extraction column is 30 mm. The annular baffle's inner diameter is 12 mm, and the plate baffle's diameter is 18 mm. A spacing of the baffles is 1 cm. Surfaces of both annular baffle and plate baffle are coated with PTFE (Polytetrafluoroethylene). An extraction system of 30% P₂O₄ (after 65% sodium soap, it is converted to nickel soap)-sulfonated kerosene-high concentration nickel sulfate/cobalt is selected. Physical parameters of the system are shown in table 1. In this experiment, 30% P₂O₄ (sulfonated kerosene as diluent) is used as a continuous phase, high concentration nickel sulfate/cobalt solution (acid leaching solution of laterite nickel ore) is used as a dispersed phase, and the gas incoming is air.

TABLE 1

| | Concen- | Concen- | | | inter- |
|---|---|---|---|---|---|
| | tration | tration | | vis- | facial |
| | of Ni²⁺ | of Co²⁺ | Density | cosity | tension |
| | (g/L) | (g/L) | (kg/m³) | (cP) | (mN/m) |
| Continuous Phase | 16.86 | / | 0.867 | 4.11 | 9.56 |
| Dispersed Phase | 107.32 | 14.21 | 1.337 | 4.95 | |

The same extraction column and extraction system are used in Comparison Embodiments 1-2 and Embodiments 1-7.

### Comparison Embodiment 1

When there is no external energy introduced, that is, energy consumption is 0 kW/h, and a sum of liquid-liquid two-phase flow is 16.38 L/h, the extraction column is flooded, and liquid holdup of the dispersed phase is 24.54%. An average droplet diameter of the dispersed phase droplets is 2.27 mm, a mass transfer area is 0.92 m², and the number of mass transfer units is 4.3;
wherein, the sum of liquid-liquid two-phase flow refers to a sum of the continuous phase flow and the dispersed phase flow. The following references to liquid-liquid two-phase are the same and no longer repeated.

### Comparison Embodiment 2

When external energy is introduced into the extraction column in the form of pulse, energy consumption is 0.18 KW/h, and a sum of liquid-liquid two-phase flow is 22.17 L/h, the extraction column is flooded, and liquid holdup of the dispersed phase is 35.41%. An average droplet diameter of the dispersed phase droplets is 1.04 mm, a mass transfer area is 2.99 m², and the number of mass transfer units is 5.8.

### Embodiment 1

In this embodiment, bubbles are introduced into a baffle extraction column by a gas distribution device installed at a bottom of the baffle extraction column to replace pulse energy. When energy consumption is 0.025 KW/h, a gas phase flow rate is 22.6 L/h, and a sum of liquid-liquid two-phase flow rate is 20.65 L/h. The extraction column has flooding. At this time, liquid holdup of the dispersed phase is 31.34%, a pipe diameter of the gas outlet is 2 mm, an average droplet diameter of the dispersed phase droplets is 1.48 mm, a mass transfer area is 1.84 m², and the number of mass transfer units is 7.2. See Table 2 for details.

### Embodiment 2

In this embodiment, bubbles are introduced into a baffle extraction column by a gas distribution device installed at a bottom of the baffle extraction column to replace pulse energy. When energy consumption is 0.005 kW/h, a gas phase flow rate is 45.2 L/h, and a sum of liquid-liquid two-phase flow rate is 19.54 L/h. The extraction column has flooding. At this time, liquid holdup of the dispersed phase is 28.85%, a pipe diameter of the gas outlet is 3 mm, an average droplet diameter of the dispersed phase droplets is 1.36 mm, a mass transfer area is 1.80 m², and the number of mass transfer units is 7.9. See Table 2 for details.

### Embodiment 3

In this embodiment, bubbles are introduced into a baffle extraction column by a gas distribution device installed at a bottom of the baffle extraction column to replace pulse energy. When energy consumption is 0.033 kW/h, a gas phase flow rate is 34.2 L/h, and a sum of liquid-liquid two-phase flow rate is 19.5 L/h. The extraction column has flooding. At this time, liquid holdup of the dispersed phase is 30.14%, a pipe diameter of the gas outlet is 4 mm, an average droplet diameter of the dispersed phase droplets is 1.39 mm, a mass transfer area is 1.81 m², and the number of mass transfer units is 7.8. See Table 2 for details.

### Embodiment 4

In this embodiment, bubbles are introduced into a baffle extraction column by a gas distribution device installed at a bottom of the baffle extraction column to replace pulse energy. When energy consumption is 0.05 kW/h, a gas phase flow rate is 45.2 L/h, and a sum of liquid-liquid two-phase flow rate is 19.54 L/h. The extraction column has flooding. At this time, liquid holdup of the dispersed phase is 28.01%, a pipe diameter of the gas outlet is 6 mm, an average droplet diameter of the dispersed phase droplets is 1.91 mm, a mass transfer area is 1.14 m², and the number of mass transfer units is 4.7. See Table 2 for details.

### Embodiment 5

In this embodiment, bubbles are introduced into a baffle extraction column by a gas distribution device installed at a bottom of the baffle extraction column to replace pulse energy. When energy consumption is 0.05 KW/h, a gas phase flow rate is 45.2 L/h, and a sum of liquid-liquid two-phase flow rate is 19.54 L/h. The extraction column has flooding. At this time, liquid holdup of the dispersed phase is 30.19%, a pipe diameter of the gas outlet is 1 mm, an average droplet diameter of the dispersed phase droplets is 1.09 mm, a mass transfer area is 2.93 m², and the number of mass transfer units is 5.6. See Table 2 for details.

### Embodiment 6

In this embodiment, bubbles are introduced into a baffle extraction column by a gas distribution device installed at a bottom of the baffle extraction column to replace pulse energy. When energy consumption is 0.082 kW/h, a gas phase flow rate is 55 L/h, and a sum of liquid-liquid two-phase flow rate is 19.5 L/h. The extraction column has flooding. At this time, liquid holdup of the dispersed phase is 24.33%, a pipe diameter of the gas outlet is 3 mm, an average droplet diameter of the dispersed phase droplets is 1.62 mm, a mass transfer area is 1.12 m², and the number of mass transfer units is 4.3. See Table 2 for details.

### Embodiment 7

In this embodiment, bubbles are introduced into a baffle extraction column by a gas distribution device installed at a bottom of the baffle extraction column to replace pulse energy. When energy consumption is 0.02 kW/h, a gas phase flow rate is 19.5 L/h, and a sum of liquid-liquid two-phase flow rate is 21 L/h. The extraction column has flooding. At this time, liquid holdup of the dispersed phase is 32.17%, a pipe diameter of the gas outlet is 3 mm, an average droplet diameter of the dispersed phase droplets is 2.03 mm, a mass transfer area is 1.33 m², and the number of mass transfer units is 4.9. See Table 2 for details.

TABLE 2

| | | Sum of | | | average |
|---|---|---|---|---|---|
| | Gas | liquid- | | Pipe | droplet |
| | in- | liquid | | dia- | diameter |
| | jection | two- | | meter | of the |
| | flow | phase | | of the | dispersed |
| | rate | flow rate | | gas | phase |
| | D₃ | (D₁ + D₂) | D₃/ | outlet | droplets |
| | (L/h) | (L/h) | (D₁ + D₂) | (mm) | (mm) |
| Embodiment 1 | 22.6 | 20.65 | 1.09 | 2 | 1.48 |
| Embodiment 2 | 45.2 | 19.54 | 2.3 | 3 | 1.36 |
| Embodiment 3 | 34.2 | 19.5 | 1.75 | 4 | 1.39 |
| Embodiment 4 | 45.2 | 19.54 | 2.3 | 6 | 1.91 |
| Embodiment 5 | 45.2 | 19.54 | 2.3 | 1 | 1.09 |
| Embodiment 6 | 55 | 19.5 | 2.82 | 3 | 1.62 |
| Embodiment 7 | 19.5 | 21 | 0.93 | 3 | 2.03 |

In the Embodiments 1-3, the ratio of the gas injection flow rate to the sum of the liquid-liquid two-phase flow rate is in an appropriate range (1≤D3/(D1+D2)≤2.5) and the pipe diameter of the gas outlet is also in the appropriate range. At this time, a average droplet diameter of the dispersed phase droplets may be controlled between 1.3 mm and 1.5 mm, and a size of the dispersed phase droplets is appropriate (suitable morphology), which is beneficial to increase the mass transfer driving force. Further, in some embodiments, the diameter of the gas outlet is 3 mm to 4 mm, and an outlet diameter within the optimal range (3 mm to 4 mm) is more conducive to improving mass transfer efficiency. Further, in some embodiments, a diameter of the gas outlet is 3 mm. At this point, the mass transfer effect is the best. The number of mass transfer units is higher, and the mass transfer effect is better. Especially in the Embodiments 2-3, by controlling 1.75≤D3/(D1+D2)≤2.3 and synergistically adjusting a pipe diameter of the gas outlet from 3 mm to 4 mm, a average droplet diameter of the dispersed phase droplets may be controlled from 1.35 mm to 1.4 mm, and the number of mass transfer units is close to 8, which is more conducive to increasing mass transfer driving force and increasing the number of mass transfer units, and may achieve better mass transfer effect.

In the Embodiments 4-5, although the ratio of the gas injection flow rate to the sum of the liquid-liquid two-phase flow rate is in an appropriate range, the pipe diameter of the gas outlet is not in a appropriate range. At this time, the dispersed phase droplets with suitable morphology may not be obtained. In the Embodiment 4, the pipe diameter of the gas outlet is too large, resulting in the average diameter of the formed dispersed phase droplets is too large. At this time, it is not conducive to improving the mass transfer driving force, and the number of mass transfer units is significantly reduced. In the Embodiment 5, the pipe diameter of the gas outlet is too small. At this time, the average diameter of formed dispersed phase droplets is small, the internal circulation inside the dispersed phase droplet is reduced, and thrust inside and outside a phase interface is reduced, which is not conducive to the mass transfer.

In the Embodiments 6-7, although the pipe diameter of the gas outlet is in an appropriate range, a ratio of the gas injection flow rate to the sum of the liquid-liquid two-phase flow rate is not in a appropriate range, especially the gas injection flow range is not appropriate. At this time, it is not conducive to obtaining suitable morphology of dispersed phase droplets, and sizes of the dispersed phase droplets are not appropriate, resulting in low mass transfer effect, but it is still better than the mass transfer effect without external energy introduction in the Comparison Embodiment 1. The Comparison Embodiment 2 is a conventional technical means of the prior art. Under the extraction column and the extraction system described in this disclosure, only 5.8 mass transfer units may be achieved in the Comparison Embodiment 2, which is much lower than the number of mass transfer units 7.9 in the Embodiment 2, about 2.1 lower.

In the present disclosure, based on a baffle extraction column, external field energy (such as stirring, pulse) introduced into the extraction column is improved to a mild gas-driven dispersion method. Starting from structure of the baffle extraction column, a gas distribution device is set inside it. Through turbulent effect of bubble floating, dispersion behavior of a dispersed phase is improved, a mixing process of a liquid-liquid system is strengthened, and a extraction mass transfer process is strengthened.

This disclosure controls the ratio of the flow rate of the dispersed phase and the flow rate of the continuous phase in the extraction process to the flow rate of the incoming gas within an appropriate range, which may better fulfil the turbulent effect of the gas and improve the mixing state of the liquid-liquid system (continuous phase-dispersed phase system). After the gas is introduced into the liquid-liquid system, it will transform into bubbles. At this time, the flow rate of the bubbles is appropriate. At the same time, the diameter of the gas outlet is controlled within an appropriate range. The ratio of the diameter of the gas outlet to the above gas-liquid flow rate is controlled within an appropriate range. In coordination, it is beneficial for controlling an average droplet diameter of formed dispersed phase droplets within a range of 1.3 mm to 1.5 mm. At this time, the size of the dispersed phase droplets is appropriate. The appropriate droplet size is beneficial for increasing driving force of mass transfer, improving mass transfer efficiency, and achieving better mass transfer efficiency, especially controlling a average droplet diameter of dispersed phase droplets within a range of 1.35 mm to 1.4 mm results in the best mass transfer efficiency.

The provided technical solutions bring at least the following beneficial effects: in this disclosure, by setting a gas distribution device in the accommodating cavity of the extraction column, the diameter of the gas outlet of the gas distribution device is adjusted to a suitable range. The gas flows into the gas distribution device through the gas inlet pipeline and then flows out from the gas outlet to the accommodating cavity. After the gas contacts a liquid phase, it changes into bubbles. By using a turbulent effect of bubbles floating up in the liquid phase, collision and shearing the dispersed phase, dispersed phase droplets are formed. In this disclosure, the injection flow of the gas is controlled in an appropriate range and the diameter of the gas outlet is in an appropriate range, which is conducive to formation of dispersed phase droplets with appropriate size, so that the dispersed phase droplets are dispersed in the continuous phase in a good droplet morphology. The average diameter of the dispersed phase droplets is in a suitable range, which is beneficial to improve the mass transfer driving force and strengthen the mass transfer effect.

The above are only better implementation embodiments of this disclosure, and they are not used to limit this disclosure. Any modifications, equivalent replacements, improvements and so on, made within the spirit and principles of this disclosure should be included in the scope of protection of this disclosure.

What is claimed is:

1. An extraction column for metal separation in an acid leaching solution of laterite nickel ore, wherein the extraction column comprises an extraction column tube body and a gas distribution device;
an interior of the extraction column tube body is provided with an accommodating cavity for containing a continuous phase and a dispersed phase, making the continuous phase and the dispersed phase in countercurrent contact in the accommodating cavity; and
the extraction column tube body is connected with the gas distribution device to make the gas distribution device pass gas into the accommodating cavity.

2. The extraction column of claim 1, wherein the gas distribution device comprises a gas distribution pipeline network;
the gas distribution pipeline network is formed by a plurality of splicing gas distribution pipelines; and
an end of each the gas distribution pipeline is provided with a gas outlet component; and
the gas distribution pipeline network is provided with an gas inlet pipeline, making a gas flow from the gas inlet pipeline into the gas distribution pipeline of the gas distribution pipeline network and flow out to the accommodating cavity through the gas outlet component.

3. The extraction column of claim 2, wherein a cross section of the gas distribution pipeline network is a central symmetric figure;
an outer contour of the central symmetric figure extends to an inner wall of the extraction column tube body; and
the central symmetric figure comprises at least one of a square, a regular hexagon, or other regular polygon.

4. The extraction column of claim 3, wherein the gas inlet pipeline is arranged at a center position of a side of the gas distribution pipeline network facing a bottom of the extraction column tube body;
a pipe diameter of the gas inlet pipeline is larger than a pipe diameter of the gas distribution pipeline.

5. The extraction column of claim 2, wherein the gas outlet component comprises a connecting pipe and a gas outlet; and
one end of the connecting pipe is connected with the gas distribution pipeline, and the other end of the connecting pipe bends towards the bottom of the extraction column tube body and is connected with an inlet end of the gas outlet.

6. The extraction column of claim 5, wherein a cross-sectional area of the inlet end of the gas outlet is larger than a cross-sectional area of an outlet end of the gas outlet.

7. The extraction column of claim 5, the other end of the connecting pipe is bent 45° to 90° towards the bottom of the extraction column tube body.

8. The extraction column of claim 1, wherein the bottom of the accommodating cavity is provided with the gas distribution device.

9. The extraction column of claim 1, wherein an inner wall of the accommodating cavity is provided with spaced baffles, and the baffles comprises a annular baffle and a plate baffle.

10. The extraction column of claim 9, wherein the annular baffle and the plate baffle are cross-set in turn.

11. The extraction column of claim 10, wherein a ring inner diameter of the annular baffle is 40% to 70% of an inner diameter of the extraction column tube body.

12. The extraction column of claim 11, wherein a ratio of a projected area of the plate baffle to the annular baffle along a height direction of the extraction column tube body is 0.3 to 0.55.

13. The extraction column of claim 1, wherein the gas distribution device is connected with a gas inlet peristaltic pump on a side of the extraction column tube body.

14. The extraction column of claim 13, wherein a check valve is provided between the gas distribution device and the gas inlet peristaltic pump, and the check valve is a one-way valve, and the check valve is used for gas intake from an outside of the extraction column to an inside of the extraction column.

15. The extraction column of claim 5, wherein the gas outlet is a conical joint.

16. An extraction process of an extraction column for metal separation in an acid leaching solution of laterite nickel ore, wherein, the extraction column comprises an extraction column tube body and a gas distribution device;
an interior of the extraction column tube body is provided with an accommodating cavity for containing a continuous phase and a dispersed phase, making the continuous phase and the dispersed phase in countercurrent contact in the accommodating cavity; and
the extraction column tube body is connected with the gas distribution device to make the gas distribution device pass gas into the accommodating cavity; and
the gas distribution device comprises a gas distribution pipeline network; and
the gas distribution device is connected with a gas inlet peristaltic pump on the side of the extraction column tube body; and
the gas distribution pipeline network is formed by a plurality of splicing gas distribution pipelines; and
an end of each the gas distribution pipeline is provided with a gas outlet component; and
the gas distribution pipeline network is provided with an gas inlet pipeline, making gas flow from the gas inlet pipeline into the gas distribution pipeline of the gas distribution pipeline network and flow out to the accommodating cavity through the gas outlet component; and the gas outlet component comprises a connecting pipe and a gas outlet;
the extraction process comprises following steps:
(1) injecting the continuous phase into the accommodating cavity of the extraction column through a top of the extraction column, and injecting the dispersed phase into the accommodating cavity of the extraction column through a bottom of the extraction column to make the continuous phase and the dispersed phase be in countercurrent contact in the accommodating cavity;
(2) activating a gas inlet peristaltic pump on a side of the extraction column to make the gas flow into the gas distribution pipeline of the gas distribution pipeline network through the gas inlet pipeline and flow out to the accommodating cavity through an outlet end of the gas outlet.

17. The extraction process of claim 16, wherein the continuous phase is a mixed solution of extractant P₂O₄ and sulfonated kerosene;
the dispersed phase is a sulfate solution comprising Ni²⁺, Co²⁺, Mn²⁺, Mg²⁺, Cu²⁺, and Zn²⁺; and
the gas is selected from at least one of air, nitrogen, and carbon dioxide.

18. The extraction process of claim 16, further comprising:
making the extraction process satisfy: 1≤D3/(D1+D2)≤2.5, and a diameters of the gas outlet ranging from 2 mm to 4 mm;
wherein an injection flow rate of the continuous phase is recorded as D1 L/h, an injection flow rate of the dispersed phase is recorded as D2 L/h, and an injection flow rate of the gas is recorded as D3 L/h.

19. The extraction process of claim 16, wherein an effect height of the extraction column ranging from 1.8 m to 2.2 m, an inner diameter of the extraction column ranging from 28 mm to 32 mm; and
the accommodating cavity of the extraction column is provided with baffles, the spacing of the baffles ranging from 1 cm to 1.5 cm.

20. The extraction process of claim 18, further comprising:
making the extraction process further satisfy 1.75≤D3/(D1+D2)≤2.3, and a diameters of the gas outlet ranging from 3 mm to 4 mm.
